(19) United States
(12) Patent Application Publication
(10) Pub. No.: US 2026/0109326 A1
(43) Pub. Date: Apr. 23, 2026

(54) REAR WINDOW WIPER CONTROL ALGORITHM

(71) Applicant: Rivian IP Holdings, LLC, Irvine, CA (US)

(72) Inventors: Adam Jarrett SMITH, Irvine, CA (US); Stuart BROWN, Swindon (GB)

(21) Appl. No.: 19/364,426

(22) Filed: Oct. 21, 2025

Related U.S. Application Data
(60) Provisional application No. 63/710,424, filed on Oct. 22, 2024.

(51) Int. Cl. B60S 1/08

(52) U.S. Cl. CPC B60S 1/0844; B60S 1/0866; B60S 1/0896

(57) ABSTRACT

A vehicle includes a front windshield wiper and a front windshield wiper actuator configured to actuate the front windshield wiper to wipe a front windshield of the vehicle. The vehicle includes a rear window wiper and a rear window wiper actuator configured to actuate the rear window wiper to wipe a rear window of the vehicle. A precipitation sensor configured to sense precipitation in front of the vehicle. A control system is configured to control a frequency of the front windshield wiper actuator and a frequency of the rear window wiper actuator based on an output of the precipitation sensor. The frequency of the rear window wiper may be proportional to the frequency of the front windshield wiper with adjustments for inputs such as vehicle speed, camera outputs, and current drawn by the rear window wiper actuator.

### CROSS-REFERENCE TO RELATED APPLICATIONS

This application claims the benefit of U.S. Provisional Application No. 63/710,424, filed on October 22, 2024, which is assigned to the assignee hereof and are hereby expressly incorporated by reference in their entirety as if fully set forth below and for all applicable purposes.

### INTRODUCTION

The present disclosure relates to a rear window wiper control algorithm.

### SUMMARY

In one aspect, a vehicle includes a front windshield wiper and a front windshield wiper actuator configured to actuate the front windshield wiper to wipe a front windshield of the vehicle. The vehicle further includes a rear window wiper and a rear window wiper actuator configured to actuate the rear window wiper to wipe a rear window of the vehicle. The vehicle includes a precipitation sensor configured to sense precipitation in front of the vehicle. A control system of the vehicle is configured to control a frequency of the front windshield wiper actuator and a frequency of the rear window wiper actuator based on an output of the precipitation sensor.

In some embodiments, the control system is configured to, if the frequency of the front windshield wiper actuator is above a first frequency, select the frequency of the rear window wiper actuator to be proportional to the first frequency. If the frequency of the front windshield wiper actuator is below the first frequency, the control system may select the frequency of the rear window wiper actuator based on the output of the precipitation sensor.

In some embodiments, the control system is configured to, if the frequency of the front windshield wiper actuator is below the first frequency and above a second frequency lower than the first frequency, select the frequency of the rear window wiper actuator based on the output of both of the precipitation sensor and the frequency of the front windshield wiper actuator.

In some embodiments, the control system is configured to, if the frequency of the front windshield wiper actuator is below the second frequency select the frequency of the rear window wiper actuator based on the output of the precipitation sensor without reference to the frequency of the front windshield wiper actuator.

In some embodiments, the control system is configured to, if the frequency of the front windshield wiper actuator is below the first frequency select the frequency of the rear window wiper actuator based on the output of the precipitation sensor and at least one of: an amount of current drawn by the rear window wiper actuator; outputs of one or more cameras of the vehicle; or a speed of the vehicle.

In some embodiments, the one or more cameras include a rear facing camera.

In some embodiments, the control system is configured to, if the frequency of the front windshield wiper actuator is below the first frequency select the frequency of the rear window wiper actuator as proportional to the frequency of the front windshield wiper actuator plus an increase amount that increases with increase of the speed of the vehicle.

In some embodiments, the control system is configured to, if the frequency of the front windshield wiper actuator is below the first frequency select the frequency of the rear window wiper actuator as proportional to the frequency of the front windshield wiper actuator plus an increase amount that increases with increase of the speed of the vehicle and an increase in precipitation detected in the outputs of the one or more cameras.

In some embodiments, the control system is configured to, if the frequency of the front windshield wiper actuator is below the first frequency select the frequency of the rear window wiper actuator as proportional to the frequency of the front windshield wiper actuator plus an increase amount that decreases with the amount of current drawn by the rear window wiper actuator.

In some embodiments, the control system is configured to, if (a) the frequency of the front windshield wiper actuator is below the first frequency and (b) an ambient temperature is below a threshold temperature, select the frequency of the rear window wiper actuator as proportional to the frequency of the front windshield wiper actuator plus an increase amount that increases with the amount of current drawn by the rear window wiper actuator.

In another aspect, a control system is configured to receive an output from a precipitation sensor configured to sense precipitation in front of a vehicle. The control system is configured to control a frequency of a front windshield wiper actuator and a frequency of a rear window wiper actuator based on the output of the precipitation sensor.

In some embodiments, the control system is configured to, if the frequency of the front windshield wiper actuator is above a first frequency, select the frequency of the rear window wiper actuator to be proportional to the first frequency. If the frequency of the front windshield wiper actuator is below the first frequency, the control system may select the frequency of the rear window wiper actuator based on the output of the precipitation sensor.

In some embodiments, the control system is configured to, if the frequency of the front windshield wiper actuator is below the first frequency and above a second frequency lower than the first frequency, select the frequency of the rear window wiper actuator based on the output of both of the precipitation sensor and the frequency of the front windshield wiper actuator.

In some embodiments, the control system is configured to, if the frequency of the front windshield wiper actuator is below the second frequency select the frequency of the rear window wiper actuator based on the output of the precipitation sensor without reference to the frequency of the front windshield wiper actuator.

In some embodiments, the control system is configured to, if the frequency of the front windshield wiper actuator is below the first frequency select the frequency of the rear window wiper actuator based on the output of the precipitation sensor and at least one of: an amount of current drawn by the rear window wiper actuator; outputs of one or more cameras of the vehicle; or a speed of the vehicle.

In some embodiments, the one or more cameras include a rear facing camera.

In some embodiments, the control system is configured to, if the frequency of the front windshield wiper actuator is below the first frequency select the frequency of the rear window wiper actuator as proportional to the frequency of the front windshield wiper actuator plus an increase amount that increases with increase of the speed of the vehicle.

In some embodiments, the control system is configured to, if the frequency of the front windshield wiper actuator is below the first frequency select the frequency of the rear window wiper actuator as proportional to the frequency of the front windshield wiper actuator plus an increase amount that increases with increase of the speed of the vehicle and an increase in precipitation detected in the outputs of the one or more cameras.

In some embodiments, the control system is configured to, if the frequency of the front windshield wiper actuator is below the first frequency select the frequency of the rear window wiper actuator as proportional to the frequency of the front windshield wiper actuator plus an increase amount that decreases with the amount of current drawn by the rear window wiper actuator.

In some embodiments, the control system is configured to, if (a) the frequency of the front windshield wiper actuator is below the first frequency and (b) an ambient temperature is below a threshold temperature, select the frequency of the rear window wiper actuator as proportional to the frequency of the front windshield wiper actuator plus an increase amount that increases with the amount of current drawn by the rear window wiper actuator.

In another aspect, a non-transitory computer-readable medium storing executable code that, when executed by a control system of a vehicle, causes the control system to receive an output from a precipitation sensor configured to sense precipitation in front of a vehicle; and control a frequency of a front windshield wiper actuator and a frequency of a rear window wiper actuator based on the output of the precipitation sensor.

### BRIEF DESCRIPTION OF THE DRAWINGS

FIG. 1A illustrates an example vehicle in accordance with certain embodiments.

FIG. 1B illustrates a rear portion of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates a system controlling a rear window wiper in accordance with certain embodiments.

FIG. 4 illustrates a method for controlling a rear window wiper in accordance with certain embodiments.

### DETAILED DESCRIPTION

The front window wiper of some vehicles is automatically controlled based on whether rain or snow is detected. A precipitation sensor proximate the windshield senses rain or snow, and the output of the sensor is used to control operation of the front window wiper. The rear window wiper in most vehicles is controlled manually and no precipitation sensors are present at the rear of the vehicle. Using the approach described herein, automatic control of the rear window is performed without the use of a rear precipitation sensor.

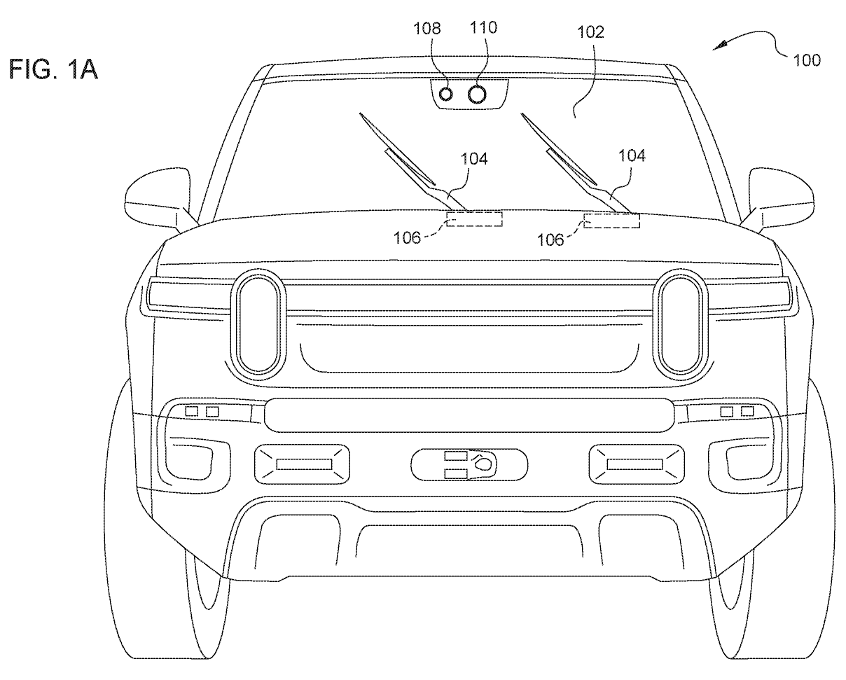

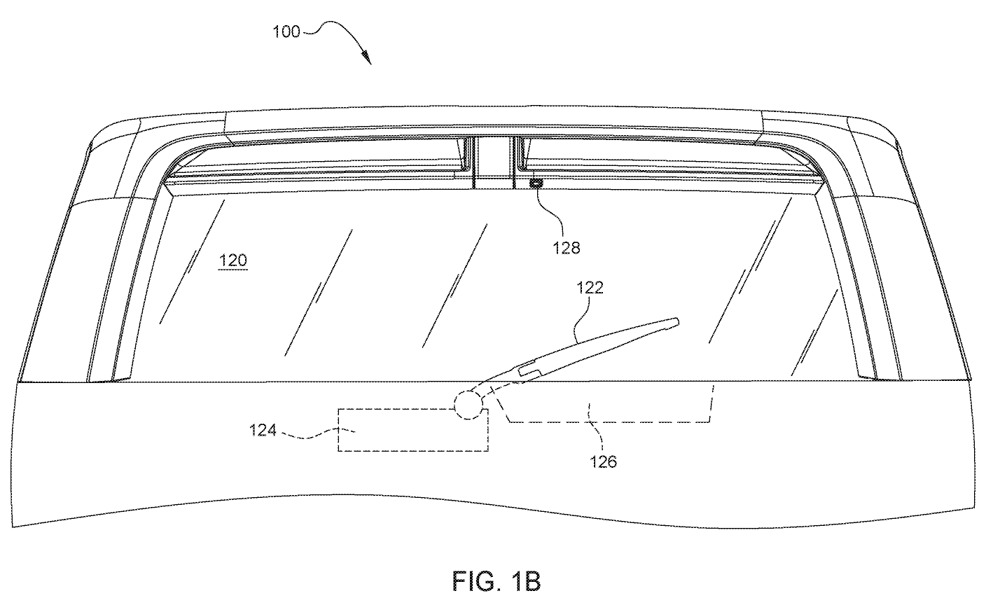

FIG. 1A illustrates an example vehicle 100. As seen in FIG. 1A, the vehicle 100 includes a front windshield 102 that is cleared from moisture and other debris by one or more front windshield wipers 104. The one or more front windshield wipers 104 may be driven by one or more actuators 106. A precipitation sensor 108 may be mounted near the windshield, such as in the interior of the vehicle 100 and facing outward through the windshield 102. The precipitation sensor 108 may be configured to sense precipitation or other debris on the windshield 102. The precipitation sensor 108 may be embodied as a sensor performing other functions, such as sensing both precipitation for purposes of controlling the actuators 106 and light for controlling headlights of the vehicle 100.

Referring to FIG. 1B, the rear window 120 of the vehicle 100 may be cleared by a rear window wiper 122 driven by an actuator 124. The rear window 120 may be the rear window of the cab of a pickup truck or a window on the tailgate, liftgate, or door of a sport utility vehicle or other type of vehicle. The rear of the vehicle 100 may define a pocket 126 in which the rear window wiper 122 rests when not in use or the rear window wiper 122 may remain exposed when not in use. The actuator 124 and pocket 126 may be within the wall, tailgate, liftgate, or door of the vehicle 100 to which the rear window 120 is mounted.

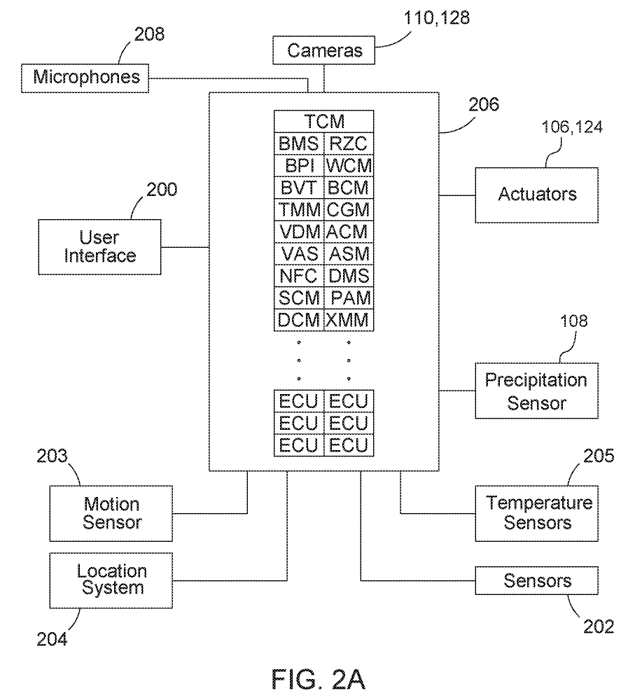

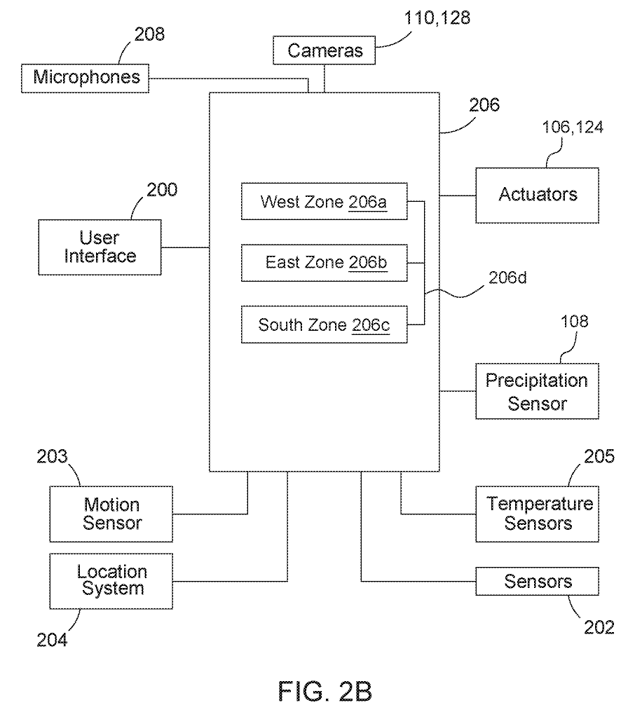

FIG. 2A illustrates example components of the vehicle 100 of FIG. 1A. As shown in FIG. 2A, the vehicle 100 includes the actuators 106, 124, precipitation sensor 108, and cameras 110, 128. The vehicle 100 may further include a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of a battery, temperature of power electronics, temperature of a drive unit and/or a motor of a drive unit, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode) and thereby control certain vehicle components related to placing the vehicle in one of the vehicle modes.

In various embodiments, the CGM ECU collects sensor signals from one or more sensors of vehicle 100. For example, the CGM ECU may collect data from the precipitation sensor 108 and other sensors 202. The sensor signals collected by the CGM ECU are then communicated to the appropriate ECUs for processing.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal controller 206a, 206b, 206c performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

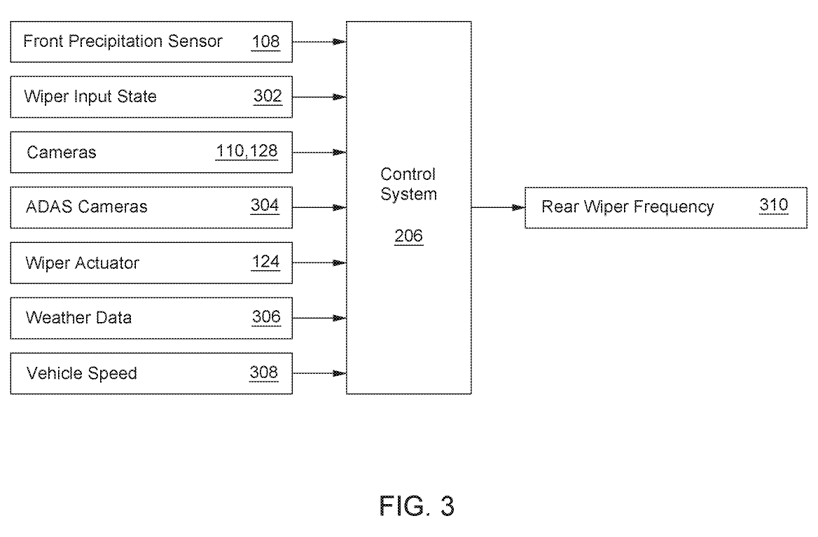

Referring to FIG. 3, the control system 206, such as an ECU of the control system 206, may receive various inputs that may be used to infer the amount of precipitation on the rear window in order to control the speed of the rear window wiper 122.

The inputs may include the output of the precipitation sensor 108 positioned under or on the front windshield 102 of the vehicle 100 and configured to produce an output indicating whether precipitation is on the front windshield and possibly an amount of such precipitation. The inputs may include the a wiper input state 302 of the one or more front windshield wipers 104, e.g., the frequency of the one or more front windshield wipers 104 as driven by the one or more actuators 106. The frequency may be a user set frequency of the front window wiper, or other value describing operation of the one or more front windshield wipers 104.

The inputs may include outputs of one or more cameras, such as the outputs of the rear facing camera 128 and possibly one or more forward facing cameras, such as the camera 110. The inputs may include outputs of cameras 304 used for providing driver assistance or for performing self-driving, e.g., automated driver assistance system (ADAS) cameras.

The inputs may include values describing the state of the actuator 124 of the rear window wiper 122, such as current draw, oscillations in the current draw, or other attributes of the actuator 124.

The inputs may include weather data 306, such as a temperature, actual precipitation, or predicted precipitation in a region including the location of the vehicle 100. The inputs may include the current speed 308 of the vehicle 100.

The inputs may include a history of any of the inputs. For example, the state of the front window wiper (e.g., frequency) in the previous 10, 20, or 30 minutes recorded in increments of 1, 2, 10, or more seconds. The history for any of the other inputs 108, 110, 124, 128, 302, 304, 306, 308 may also be used as inputs to the control system 206.

The control system 206 may process the inputs and determine a frequency 310 for the rear window wiper 122, which may include turning off the rear window wiper 122.

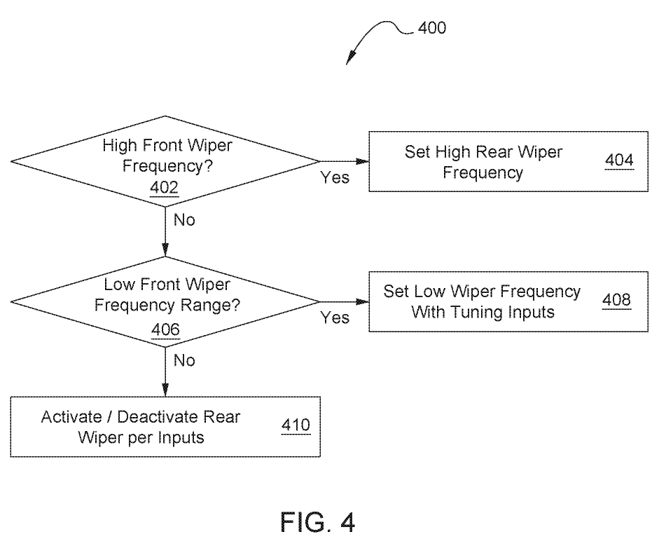

FIG. 4 illustrates an example method 400 that may be performed by the control system 206 using some or all of the inputs of FIG. 3 in order to select the frequency 310 operation of the rear window wiper 122. As used herein, the frequency of a wiper refers to the frequency at which a wiper is driven by the actuator thereof.

The method 400 may include evaluating 402 whether the front windshield wiper 104 is operating above a first frequency (e.g., a predefined high frequency). If so, the rear window wiper 122 may be set, at step 404, to a frequency corresponding to that of the front windshield wiper 104, such as proportional to the frequency of the front windshield wiper 104 or at a maximum frequency of the rear window wiper 122, such as whichever is smaller.

The method 400 may include evaluating, at step 406, whether front windshield wiper 104 is operating between the first frequency and a second frequency that is lower than the first frequency, e.g., in a predefined low frequency range below the high frequency. The second frequency defining the low frequency range may be lower than the first frequency and may be zero. If the front windshield wiper 104 is operating in the low frequency range, the method 400 may include setting, at step 408, the rear window wiper 122 to operate at a low frequency corresponding to the frequency of the front windshield wiper 104 with adjustments (e.g., increases) to the frequency of the rear window wiper 122 according to one or more inputs from FIG. 3.

If the front windshield wiper 104 is not in the low frequency range, the method 400 may include activating and/or deactivating the rear window wiper 122 at step 410 according to the inputs from FIG. 3 without reference to the frequency of the front windshield wiper 104.

Tuning according to the inputs at step 408 or activating and/or deactivating the rear window wiper 122 according to the inputs at step 410 may be performed using some or all of the following logic. In particular, the following examples illustrate increase or decrease amounts that may be applied to (e.g., added to) a frequency that is proportional to the frequency of the front windshield wiper 104 to obtain the frequency of the rear window wiper 122.

In a first example, consideration is given to the turbulence at the back of the vehicle and the possibility that water on the road may be scattered by the wheels of the vehicle and may be incident on the rear window. Accordingly, the frequency 310 of the rear window wiper may increase with vehicle speed, detected precipitation, front wiper frequency, amount of actual or predicted precipitation, the amount of precipitation detected by the precipitation sensor 108, and/or the amount of precipitation detected in outputs of cameras 110, 128. The frequency 310 may increase with increase in historical values for any of these inputs, with the amount of the increase declining with elapsed time since the historical values where recorded.

In a second example, resistance to movement of the rear window wiper 122 is reflected in the current drawn by the actuator 124. Snow may be more problematic than rain and cause more resistance and therefore cause the rear wiper motor to draw more current. Accordingly, when temperatures are below a threshold temperature (e.g., below 3, 2, 1, or 0 degrees Celsius), the frequency 310 may be increased with increasing current drawn by the rear wiper motor.

In a third example, a dry rear window 120 may cause more friction and a corresponding increase in current drawn by the rear wiper motor. Accordingly, the frequency 310 may be increased with decreasing current drawn by the rear wiper motor based on the assumption that more rain may be present. The frequency 310 may be decreased with increasing current drawn by the rear wiper motor based on the assumption that less rain may be present. Other aspects, such as current ripples in current drawn by the rear wiper motor may be caused by chatter that may indicate a dry windshield and may invoke reduction in the frequency 310. The logic of the third example may be invoked where other evidence of current rain or recent rain (e.g., within the last half hour): front window wiper turned on, rain detected in camera outputs, weather data indicating rain, and/or a temperature above 0, 1, 2, 3 or more degrees Celsius).

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A vehicle comprising:
a front windshield wiper;
a front windshield wiper actuator configured to actuate the front windshield wiper to wipe a front windshield of the vehicle;
a rear window wiper;
a rear window wiper actuator configured to actuate the rear window wiper to wipe a rear window of the vehicle;
a precipitation sensor configured to sense precipitation in front of the vehicle; and
a control system configured to control a frequency of the front windshield wiper actuator and a frequency of the rear window wiper actuator based on an output of the precipitation sensor.

2. The vehicle of claim 1, wherein the control system is configured to:
if the frequency of the front windshield wiper actuator is above a first frequency, select the frequency of the rear window wiper actuator to be proportional to the first frequency; and
if the frequency of the front windshield wiper actuator is below the first frequency, select the frequency of the rear window wiper actuator based on the output of the precipitation sensor.

3. The vehicle of claim 2, wherein the control system is configured to, if the frequency of the front windshield wiper actuator is below the first frequency and above a second frequency lower than the first frequency, select the frequency of the rear window wiper actuator based on the output of both of the precipitation sensor and the frequency of the front windshield wiper actuator.

4. The vehicle of claim 3, wherein the control system is configured to, if the frequency of the front windshield wiper actuator is below the second frequency, select the frequency of the rear window wiper actuator based on the output of the precipitation sensor without reference to the frequency of the front windshield wiper actuator.

5. The vehicle of claim 2, wherein the control system is configured to, if the frequency of the front windshield wiper actuator is below the first frequency, select the frequency of the rear window wiper actuator based on the output of the precipitation sensor and at least one of:
an amount of current drawn by the rear window wiper actuator;
outputs of one or more cameras of the vehicle; or
a speed of the vehicle.

6. The vehicle of claim 5, wherein the one or more cameras include a rear facing camera.

7. The vehicle of claim 5, wherein the control system is configured to, if the frequency of the front windshield wiper actuator is below the first frequency, select the frequency of the rear window wiper actuator as proportional to the frequency of the front windshield wiper actuator plus an increase amount that increases with an increase of the speed of the vehicle.

8. The vehicle of claim 5, wherein the control system is configured to, if the frequency of the front windshield wiper actuator is below the first frequency, select the frequency of the rear window wiper actuator as proportional to the frequency of the front windshield wiper actuator plus an increase amount that increases with an increase of the speed of the vehicle and an increase in precipitation detected in the outputs of the one or more cameras.

9. The vehicle of claim 5, wherein the control system is configured to, if the frequency of the front windshield wiper actuator is below the first frequency, select the frequency of the rear window wiper actuator as proportional to the frequency of the front windshield wiper actuator plus an increase amount that decreases with the amount of current drawn by the rear window wiper actuator.

10. The vehicle of claim 5, wherein the control system is configured to, if (a) the frequency of the front windshield wiper actuator is below the first frequency and (b) an ambient temperature is below a threshold temperature, select the frequency of the rear window wiper actuator as proportional to the frequency of the front windshield wiper actuator plus an increase amount that increases with the amount of current drawn by the rear window wiper actuator.

11. A control system configured to:
receive an output from a precipitation sensor configured to sense precipitation in front of a vehicle; and
control a frequency of a front windshield wiper actuator and a frequency of a rear window wiper actuator based on the output of the precipitation sensor.

12. The control system of claim 11, further configured to:
if the frequency of the front windshield wiper actuator is above a first frequency, select the frequency of the rear window wiper actuator to be proportional to the first frequency; and
if the frequency of the front windshield wiper actuator is below the first frequency, select the frequency of the rear window wiper actuator based on the output of the precipitation sensor.

13. The control system of claim 12, further configured to, if the frequency of the front windshield wiper actuator is below the first frequency and above a second frequency lower than the first frequency, select the frequency of the rear window wiper actuator based on the output of both of the precipitation sensor and the frequency of the front windshield wiper actuator.

14. The control system of claim 13, further configured to, if the frequency of the front windshield wiper actuator is below the second frequency, select the frequency of the rear window wiper actuator based on the output of the precipitation sensor without reference to the frequency of the front windshield wiper actuator.

15. The control system of claim 12, further configured to, if the frequency of the front windshield wiper actuator is below the first frequency, select the frequency of the rear window wiper actuator based on the output of the precipitation sensor and at least one of:
an amount of current drawn by the rear window wiper actuator;
outputs of one or more cameras of the vehicle; or
a speed of the vehicle.

16. The control system of claim 15, wherein the one or more cameras include a rear facing camera.

17. The control system of claim 15, further configured to, if the frequency of the front windshield wiper actuator is below the first frequency, select the frequency of the rear window wiper actuator as proportional to the frequency of the front windshield wiper actuator plus an increase amount that increases with an increase of the speed of the vehicle.

18. The control system of claim 15, further configured to, if the frequency of the front windshield wiper actuator is below the first frequency, select the frequency of the rear window wiper actuator as proportional to the frequency of the front windshield wiper actuator plus an increase amount that increases with an increase of the speed of the vehicle and an increase in precipitation detected in the outputs of the one or more cameras.

19. The control system of claim 15, further configured to:
if the frequency of the front windshield wiper actuator is below the first frequency, select the frequency of the rear window wiper actuator as proportional to the frequency of the front windshield wiper actuator plus an increase amount that decreases with the amount of current drawn by the rear window wiper actuator; and
if (a) the frequency of the front windshield wiper actuator is below the first frequency and (b) an ambient temperature is below a threshold temperature, select the frequency of the rear window wiper actuator as proportional to the frequency of the front windshield wiper actuator plus an increase amount that increases with the amount of current drawn by the rear window wiper actuator.

20. A non-transitory computer-readable medium storing executable code that, when executed by a control system of a vehicle, causes the control system to:
receive an output from a precipitation sensor configured to sense precipitation in front of a vehicle; and
control a frequency of a front windshield wiper actuator and a frequency of a rear window wiper actuator based on the output of the precipitation sensor.
